(19) United States
(12) Patent Application Publication
(10) Pub. No.: US 2016/0160653 A1
(43) Pub. Date: Jun. 9, 2016

(54) TURBINE WHEEL FOR TURBO CHARGER

(71) Applicant: Hyundai Motor Company, Seoul (KR)

(72) Inventor: Sang Tae CHOI, Bucheon-si (KR)

(21) Appl. No.: 14/804,091

(22) Filed: Jul. 20, 2015

(30) Foreign Application Priority Data
Dec. 8, 2014 (KR) 10-2014-0175089

(51) Int. Cl. F01D 5/18; F01D 5/14; F01D 5/02

(52) U.S. Cl. CPC F01D 5/18; F01D 5/02; F01D 5/147; F05D 2220/40; F05D 2240/305; F05D 2240/306

(57) ABSTRACT

A turbine wheel for a turbine charger includes a hub and a set of wheel blades configured to be arranged around the hub. A wheel blade has a section structure of an air-foil which has a pressure side and a suction side. The turbine wheel is capable of remarkably increasing an output of a vehicle engine by increasing a rotation power of the turbine wheel to increase a compression rate of sucked air.

### CROSS-REFERENCE TO RELATED APPLICATION

This application is based on and claims the benefit of priority to Korean Patent Application No. 10-2014-0175089, filed on Dec. 8, 2014 in the Korean Intellectual Property Office, the disclosure of which is incorporated herein in its entirety by reference.

### TECHNICAL FIELD

The present disclosure relates to a turbine wheel for a turbo charger, and more particularly, to a turbine wheel for a turbo charger capable of remarkably increasing an output of a vehicle engine by increasing a rotation power of the turbine wheel to increase a compression rate of sucked air.

### BACKGROUND

A turbo charger is an engine which rotates a turbine using an exhaust gas pressure of an engine which is essentially generated in an internal combustion engine. The turbo charger pushes sucked air with a stronger pressure than an atmospheric pressure using the rotation power to increase an engine output. Compression of air causes temperature to rise and as a result, efficiency is likely to reduce. For this reason, the turbo charger has been frequently used along with an intercooler.

The turbo charger is configured to coaxially connect a turbine wheel to a compressor wheel through one rotating shaft. This makes exhaust gas to rotate the compressor wheel simultaneously with rotating a blade of the turbine wheel. It also makes the compressor to excessively supply sucked air to generate a larger output even though the same amount of fuel is used.

Examples of typical turbo chargers have been disclosed in related art. Some typically disclosed turbo chargers include a structure to prevent crack and thermal expansion, and the like of a blade for introducing air into the blade of the turbine wheel.

However, such typical turbo chargers have a technical limitation in increasing compression rate of the sucked air by the turbo charger using the turbine wheel.

As customer demands for improvement in fuel efficiency is growing, domestic and foreign car makers have progressed research and development of technologies for obtaining a larger output, even though the same amount of fuel is used, by increasing the compression rate of sucked air by the turbo charger.

### SUMMARY

The present disclosure has been made to solve the above-mentioned problems occurring in the prior art while advantages achieved by the prior art are maintained intact.

An aspect of the present disclosure provides a turbine wheel for a turbo charger capable of giving a lift to a blade by a pressure difference of an air-foil which is generated when exhaust gas flows along an outer surface of a blade by applying a section of the air-foil to the blade of the turbine wheel and increasing a rotation power of the turbine wheel by guiding the lift of the blade to apply the lift in a rotating direction of the turbine wheel.

The foregoing and other objects, features, aspects and advantages of the present disclosure will be understood and become more apparent from the following detailed description of the present disclosure. Also, it can be easily understood that the objects and advantages of the present disclosure can be realized by the units and combinations thereof recited in the claims.

According to an exemplary embodiment of the present disclosure, a turbine wheel for a turbo charger includes a hub and a set of wheel blades configured to be arranged around the hub. A wheel blade among the set of wheel blades has a section structure of an air-foil which has a pressure side and a suction side.

The section structure of the air-foil may be formed along an inflowing direction of exhaust gas.

The wheel blade may have a take-out tip through which exhaust gas is discharged.

The take-out tip of the wheel blade may have a take-out angle of 0 to 15 degrees.

The take-out tip of the wheel blade may have a take-out angle of 30 degrees.

The wheel blade may be provided with an air inflow passage through which air is introduced.

According to another exemplary embodiment of the present disclosure, a turbine wheel for a turbo charger includes a hub and a set of wheel blades configured to extend from the hub in an outer diameter direction. A wheel blade among the set of wheel blades may have a section structure of an air-foil which is formed along an inflowing direction of exhaust gas and has a pressure side and a suction side. The wheel blade may be configured to make the inflowing direction of the exhaust gas and a discharge direction of the exhaust gas orthogonal to each other.

The wheel blade may have a free end provided with a take-out tip through which exhaust gas is discharged.

The wheel blade may be provided with an air inflow passage through which air is introduced.

### BRIEF DESCRIPTION OF THE DRAWINGS

The above and other objects, features and advantages of the present disclosure will be more apparent from the following detailed description taken in conjunction with the accompanying drawings.

FIG. 1 is a perspective view illustrating a turbine wheel for a turbo charger according to an exemplary embodiment of the present disclosure.

FIG. 2 is a side view illustrating the turbine wheel for a turbo charger according to an exemplary embodiment of the present disclosure.

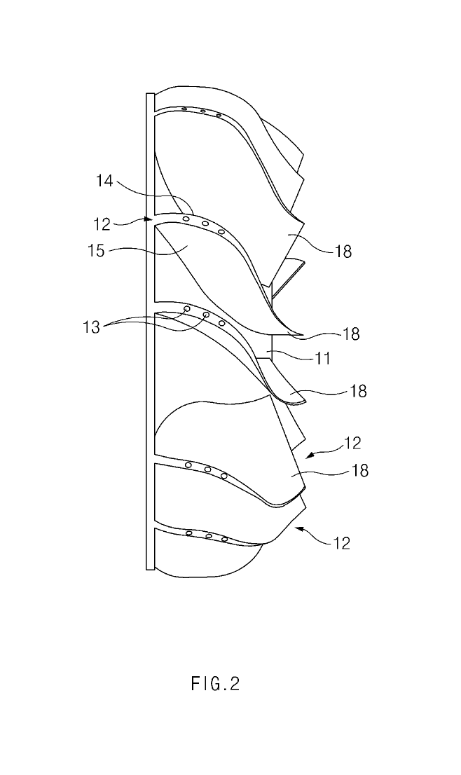

FIG. 3 is a front view illustrating the turbine wheel for a turbo charger according to an exemplary embodiment of the present disclosure.

FIG. 4 is a diagram partially illustrating a portion of a turbine wheel for a turbo charger according to another exemplary embodiment of the present disclosure.

FIG. 5 is a graph illustrating a lift-to-drag ratio (CL/CD) with respect to a lift coefficient (CL) depending on each air-foil shape of 4AX, 4BX, 4CX, 3CX, 3BY types of wheel blades with reference to a tip jet modules nomenclature of FIG. 4.

FIG. 6 is a graph illustrating drag coefficient (CD) to lift coefficient (CL) depending on shape of a triple jet type of each wheel blade.

FIG. 7 is a side view illustrating a turbine wheel for a turbo charger according to another exemplary embodiment of the present disclosure.

### DETAILED DESCRIPTION

Hereinafter, exemplary embodiments of the present disclosure will be described in detail with reference to the accompanying drawings. For reference, a size, a thickness of a line, and the like of components which are illustrated in the drawing referenced for describing exemplary embodiments of the present disclosure may be slightly exaggerated for convenience of understanding. Further, terms used to describe the present disclosure are defined in consideration of functions in the present disclosure and therefore may be changed depending on an intention, a practice, and the like of a user and an operator. Therefore, the definition of the terminologies should be construed based on the contents throughout the specification.

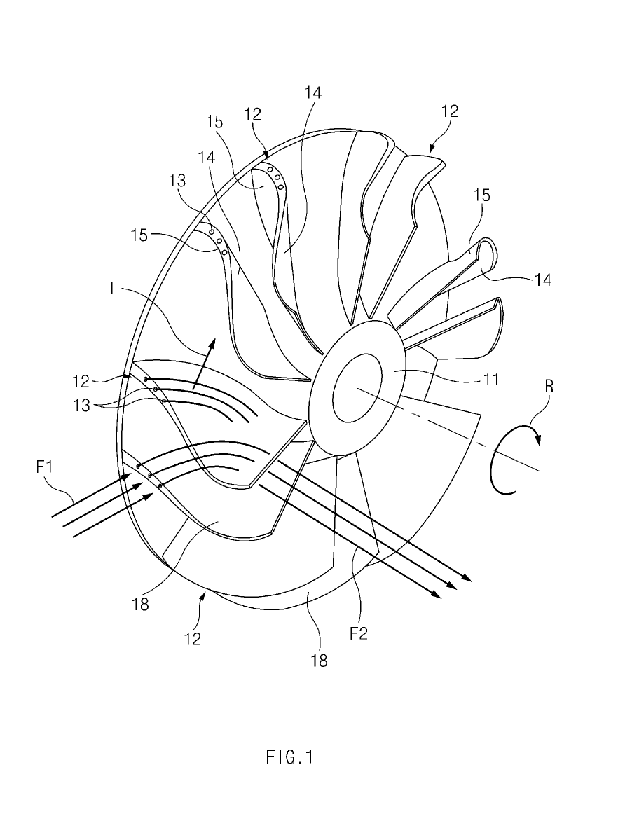

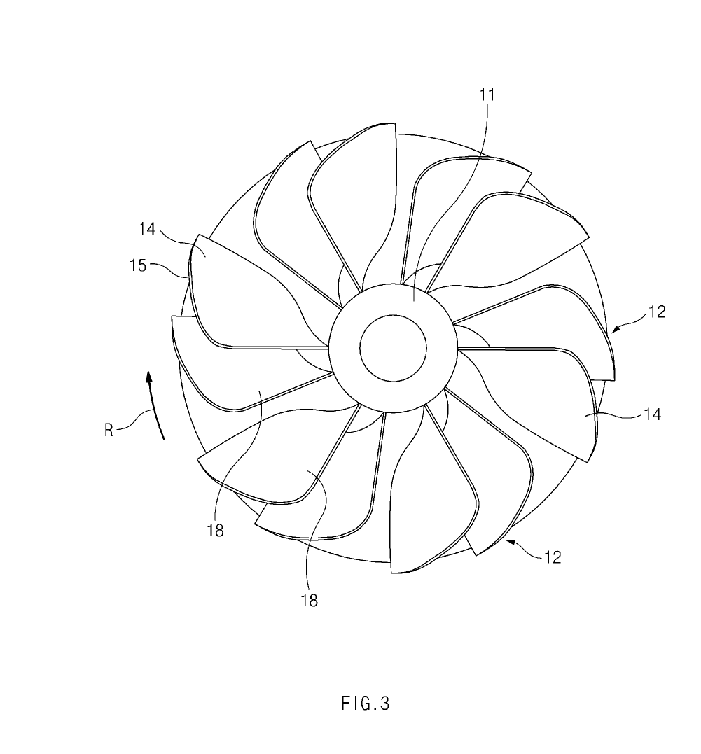

FIGS. 1 and 3 are diagrams illustrating a turbine wheel for a turbo charger according to an exemplary embodiment of the present disclosure.

As illustrated in FIG. 1, a turbine wheel 10 for a turbo charger according to an exemplary embodiment of the present disclosure includes a hub 11 and a set of wheel blades 12 arranged around the hub 11.

The hub 11 has a central portion coupled with a rotating shaft (not illustrated). The hub 11 is also coaxially coupled with a compressor wheel via the rotating shaft (not illustrated).

The set of wheel blades 12 are arranged around the hub 11 and each wheel blade 12 extends from the central portion of the hub 11 toward an outer circumferential edge.

Each wheel blade 12 has a section structure of an air-foil which is formed along an inflowing direction F1 of exhaust gas, and therefore each wheel blade 12 has a suction side 14 at which pressure is low and a pressure side 15 at which pressure is high.

Therefore, as illustrated in FIG. 1, when the exhaust gas is introduced between the wheel blades 12 along an inflowing direction F1 (that is, exhaust gas is introduced in a radial direction of the turbine wheel 10), each wheel blade 12 gives a lift (see an arrow L direction of FIG. 1) along a rotating direction (see an arrow R direction of FIG. 1) of the turbine wheel 10 by a difference in pressure between the suction side 14 and the pressure side 15.

That is, as a rotation power of the wheel blades 12 by a collision with the exhaust gas is combined with a rotation power of the lift applied to each wheel blade 12 by the pressure difference between the suction side 14 and the pressure side 15, the rotation power of the turbine wheel 10 can be increased.

Meanwhile, as the wheel blades 12 have the section structure of the air-foil, a heavy vortex may be generated at each take-out tip 18 and thus a drag is increased. At the same time, a lift-to-drag ratio is likely to reduce, which leads to lift reduction.

To cope with this, the wheel blades 12 can have the take-out tip 18 which is provided at an opposite side of the hub 11 and has the exhaust gas discharged therethrough. Therefore, the exhaust gas introduced between the wheel blades 12 of the turbine wheel 10 along the inflowing direction F1 is stably discharged through the take-out tip 18 of the wheel blades 12 along the discharge direction (see an arrow F2 direction of FIG. 1) to effectively prevent the vortex generation.

Further, the take-out tip 18 of the wheel blades 12 may extend along an axial direction of the hub 11 and may be inclinedly formed to the axial direction of the hub 11 at a predetermined angle. In this case, the exhaust gas can be more stably discharged in the outflowing direction F2 through the take-out tip 18, thereby more effectively preventing the vortex generation. As the vortex generation is prevented, the lift-to-drag ratio of each wheel blade 12 is increased (the lift is increased and the drag is reduced), such that the rotation power of the turbine wheel 10 may be more stably increased.

Further, the wheel blades 12 are provided with an air inflow passage 13 through which air is introduced. As air is introduced into the wheel blades 12 through the air inflow passage 13, it is possible to effectively prevent crack, thermal generation, and the like of the wheel blades.

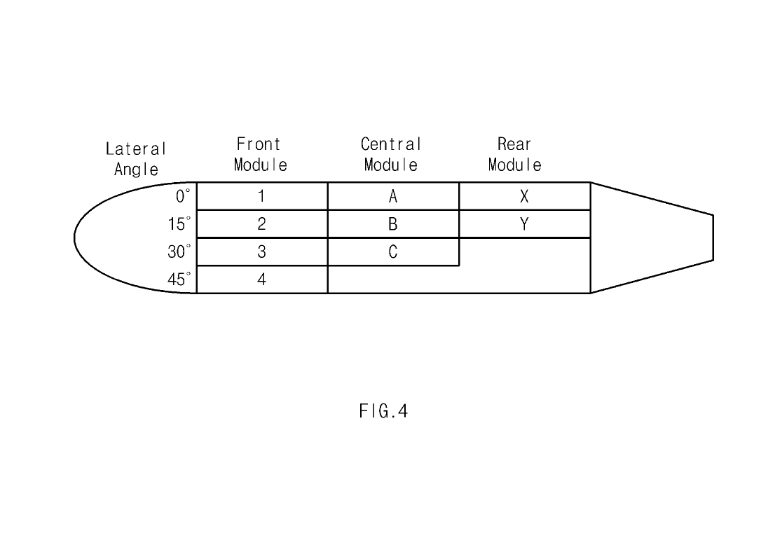

FIG. 4 illustrates a lateral angle of the air-foil based on tip jet modules nomenclature. When a chord length of a wheel blade 12 is C, a front module of FIG. 4 is a portion which corresponds to a point (0.2C) at which it is 2/10 of the chord length from the hub 11, a central module is a portion which corresponds to a point (0.5C) at which it is 5/10 of the chord length from the hub 11, and a rear module is a portion which corresponds to a point (0.8C) at which it is 8/10 of the chord length from the hub 11. According to the tip jet modules nomenclature, the wheel blade 12 is classified into a single jet, a double jet, a triple jet types, and the like as shown in the following Table 1.

TABLE 1
Single Jet

| | | |
|---|---|---|
| 1 | 4 | C |
| 2 | A | X |
| 3 | B | Y |

Double Jet

| | | |
|---|---|---|
| 1A | 3B | AX |
| 2A | 4B | BX |
| 3A | 1C | CX |
| 4A | 2C | AY |
| 1B | 3C | BY |
| 2B | 4C | CY |

Triple Jet

| | | | |
|---|---|---|---|
| 1AX | 2BX | 4CX | 3CY |
| 2AX | 3BX | 2BY | 4CY |
| 3AX | 4BX | 3BY | 1AY |
| 4AX | 3CX | 4BY | 1BY |

Meanwhile, the wheel blades 12 according to the exemplary embodiment of the present disclosure are preferably formed in the triple jet type. For example, when the triple jet type of wheel blades 12 is 3BY, a take-out angle of a front module is 30 degrees, a take-out angle of a central module is 15 degrees, and a take-out angle of a rear module is 15 degrees.

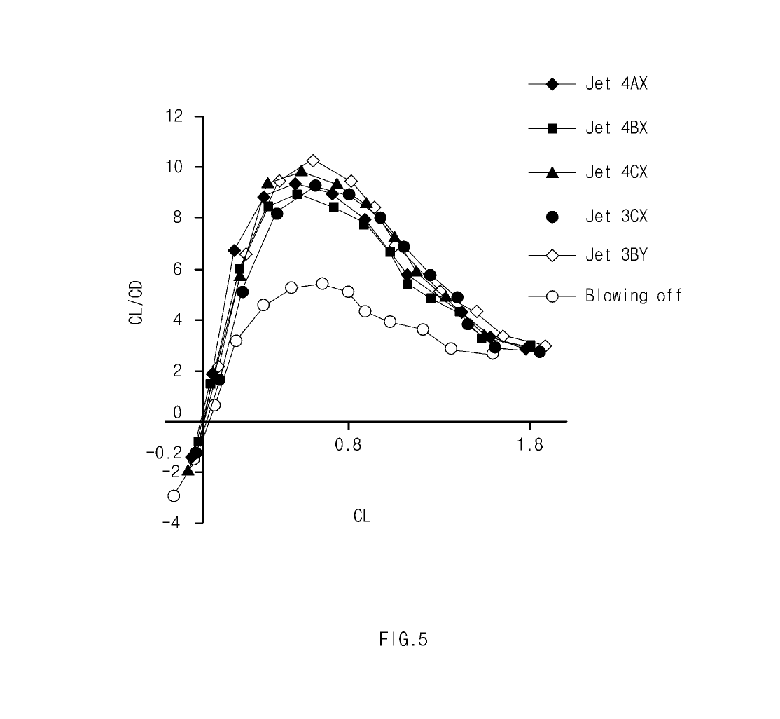

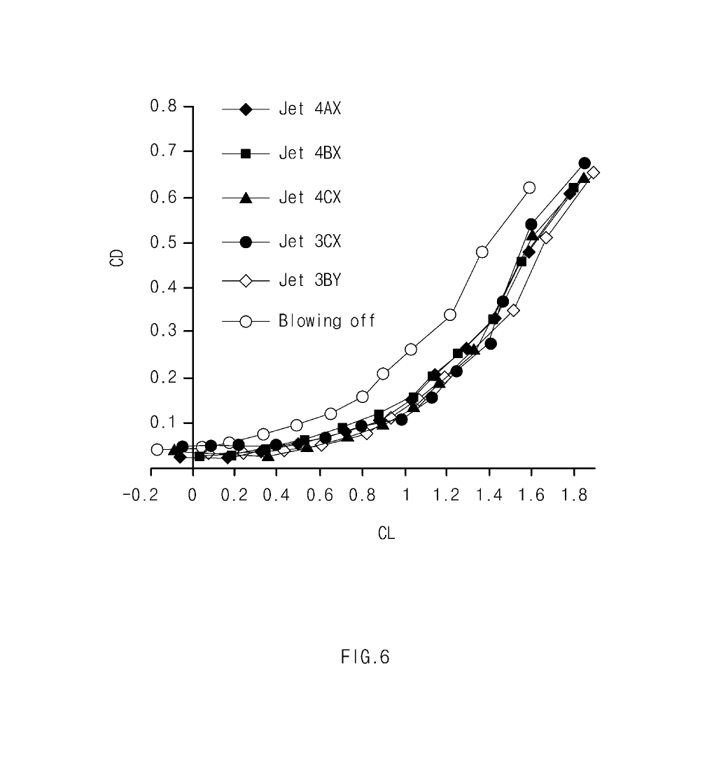

FIG. 5 is a graph illustrating a lift-to-drag ratio (CL/CD) with respect to a lift coefficient (CL) depending on each air-foil shape of 4AX, 4BX, 4CX, 3CX, 3BY types of wheel blades with reference to the tip jet modules nomenclature of FIG. 4 and FIG. 6. FIG. 5 is a graph illustrating drag coefficient (CD) to lift coefficient (CL) depending on each shape of the triple jet type of wheel blades.

It may be appreciated from FIG. 5 that the 3BY type of wheel blade 12 has the most excellent lift-to-drag ratio (CL/CL) in the same lift coefficient (CL).

Further, it may be appreciated from FIG. 6 that the 3 BY type of wheel blade 12 has the most excellent in that the larger the lift coefficient CL, the larger the drag coefficient CD.

From the above description, the take-out angle of the take-out tip 18 of a wheel blade 12 preferably ranges from 0 to 15 degrees. In particular, as can be appreciated from the result graphs of FIGS. 5 and 6, the take-out angle of the take-out tip 18 of the wheel blade 12 is most preferably 15 degrees.

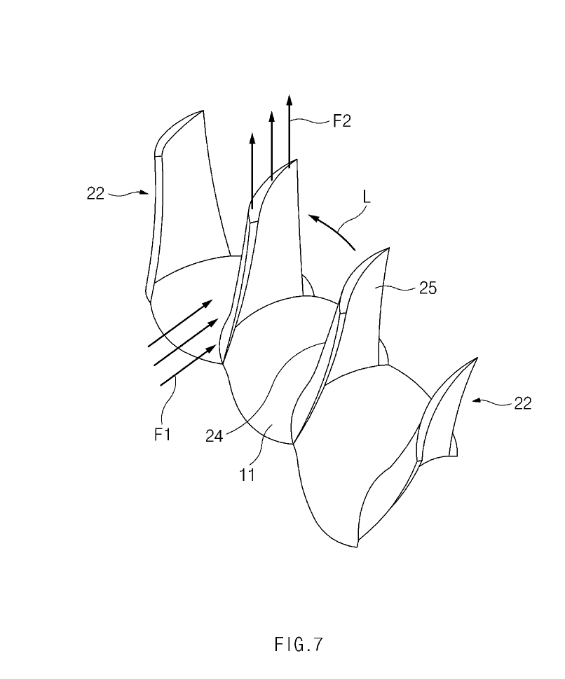

FIG. 7 is a side view illustrating a turbine wheel for a turbo charger according to another exemplary embodiment of the present disclosure.

As illustrated in FIG. 7, the turbine wheel 10 for a turbo charger according to another exemplary embodiment of the present disclosure includes the hub 11 and the set of wheel blades 22 extending from an outer circumferential surface of the hub 11 in an outer diameter direction.

The wheel blades 22 have the section structure of the air-foil which is formed along the inflowing direction F1 of the exhaust gas, and therefore each wheel blade 22 has the suction side 24 at which the pressure is low and the pressure side 25 at which the pressure is high.

Meanwhile, the wheel blades 22 are configured to make the inflowing direction F1 of the exhaust gas and the outflowing direction F2 of the exhaust gas orthogonal to each other. To this end, the free end (that is, end of the opposite side of the hub 11) of the wheel blades 22 is provided with the take-out tips 18 and the exhaust gas is discharged through the take-out tips 18 along the discharge direction F2.

According to the exemplary embodiment of the present disclosure as described above, it is possible to give lift to the wheel blades 12 and 22 by the pressure difference of the air-foil which is generated when the exhaust gas flows along the outer surface of the wheel blades 12 and 22. This can be done by applying the section of the air-foil to the wheel blades 12 of the turbine wheel 10 and increasing the rotation power of the turbine wheel 10 by applying the lift of the wheel blades 12 and 22 in the rotating direction of the turbine wheel 10. This can increase the compression rate of the sucked air and remarkably increase the output of the vehicle engine accordingly.

Hereinabove, the specific embodiments of the present disclosure are described but the present disclosure is not limited to the disclosed embodiments and the accompanying drawings and may be variously changed without departing from the spirit and the scope of the present disclosure.

What is claimed is:

1. A turbine wheel for a turbo charger, comprising:
a hub; and
a plurality of wheel blades configured to be arranged around the hub,
wherein a wheel blade among the plurality of wheel blades has a section structure of an air-foil which has a pressure side and a suction side.

2. The turbine wheel according to claim 1, wherein the section structure of the air-foil is formed along an inflowing direction of exhaust gas.

3. The turbine wheel according to claim 1, wherein the wheel blade has a take-out tip through which exhaust gas is discharged.

4. The turbine wheel according to claim 3, wherein the take-out tip of the wheel blade has a take-out angle of 0 to 15 degrees.

5. The turbine wheel according to claim 3, wherein the take-out tip of the wheel blade has a take-out angle of 30 degrees.

6. The turbine wheel according to claim 1, wherein the wheel blade is provided with an air inflow passage through which air is introduced.

7. A turbine wheel for a turbo charger, comprising:
a hub; and
a plurality of wheel blades configured to extend from the hub in an outer diameter direction,
wherein a wheel blade among the plurality of wheel blades has a section structure of an air-foil which is formed along an inflowing direction of exhaust gas and has a pressure side and a suction side, and
the wheel blade is configured to make the inflowing direction of the exhaust gas and a discharge direction of the exhaust gas orthogonal to each other.

8. The turbine wheel according to claim 7, wherein the wheel blade has a free end provided with a take-out tip through which exhaust gas is discharged.

9. The turbine wheel according to claim 7, wherein the wheel blade is provided with an air inflow passage through which air is introduced.
